(19) United States
(12) Patent Application Publication
(10) Pub. No.: US 2006/0057711 A1
(43) Pub. Date: Mar. 16, 2006

(54) Air injected composter

(76) Inventors: Carmen G. Timm, Spring, TX (US); Marisol A. Timm, McKinney, TX (US)

Correspondence Address: CARMEN G. TIMM, 17319 CYPRESS SPRING DR., SPRING, TX, 77388, US

(21) Appl. No.: 10/942,503

(22) Filed: Sep. 16, 2004

(51) Int. Cl. C05F 17/02

(52) U.S. Cl. 435/290.1

(57) ABSTRACT

The invention is an Air Injected Composter that accelerates the composting process by injecting air into the composting material, voiding the need for turning the composting matter for aeration. As the composting material is being aerated by air injected directly into the composting material, no other intervention is needed for the composting process to continue on an accelerated pace.

### CROSS REFFERENCE TO RELATED APPLICATIONS

Not applicable

### STATEMENT REGARDING FEDERALLY SPONSORED RESEARCH OR DEVELOPMENT

Not applicable

### BACKGROUND OF THE INVENTION

The present invention relates to the field of organic gardening and organic farming; specifically, devices that facilitate the decomposition of organic materials into compost and nutrients that are then recycled for fertilizing the soils and plants.

### DESCRIPTION OF RELATED ART

As shown in the reference U.S. Pat. Nos. 6,284,528; 6,264,359; 5,846,815 and 5,700,689 the prior art has an abundance of diverse composters.

While the prior art inventions are adequate for the basic purpose and function for which they have been designed, they fail to provide a device that is simple and minimizes the attention needed for it to perform its function.

The process of composting depends on bacterial activity and the “good bacteria” depend on the presence of oxygen to digest and metabolize the organic matter. Almost all prior art depends on highly ventilated enclosures and/or on mechanically rotating the compost to aerate it and provide the needed oxygen for the process to continue. Failure to provide air to the composting process causes the process to slow or stop. In some cases the lack of aeration causes the process to become anaerobic, generating obnoxious fumes and odors.

Almost invariably, the prior art composters need to be frequently rotated, liquids and/or compost from the composting process separated and removed. Unfortunately, those chores tend to be burdensome and discourage many individuals that would otherwise embrace the idea of recycling organic material for the benefit of the environment.

### BRIEF SUMMARY OF THE INVENTION

The AIR INJECTED COMPOSTER basically consists of an Air Pump (1), Air Duct (2) and a Composter Box (3) arranged in such a way that air is injected into the composting material by the Air Delivery Device (4), preferably at or near the bottom of the box to insure the compost material is properly aerated. This arrangement allows for vigorous bacterial activity, which in turn accelerates the composting process and prevents anaerobic reactions.

### BRIEF DESCRIPTION OF THE SEVERAL VIEWS OF THE DRAWINGS

FIG. 1 is a schematic showing the typical arrangement of the AIR INJECTED COMPOSTER.

### DETAILED DESCRIPTION OF THE INVENTION

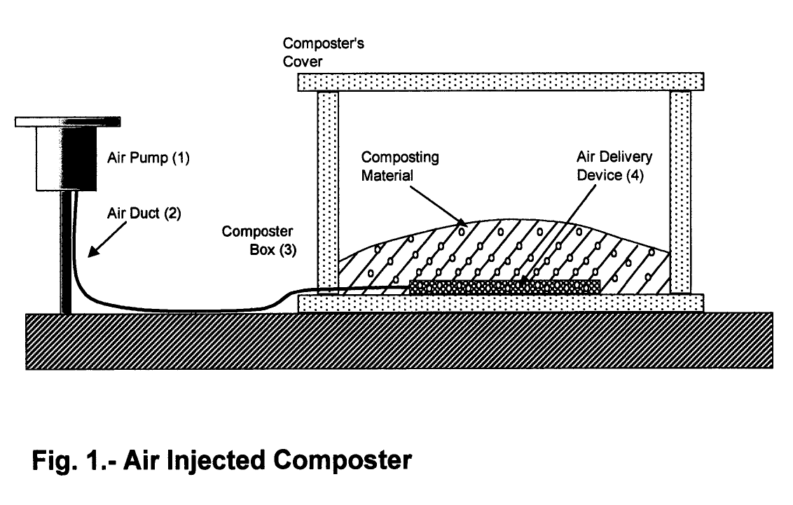

As shown in FIG. 1 the AIR INJECTED COMPOSTER is made of an Air Pump (1), Air Duct (2) and a Composter Box (3). The Air Pump (1) pumps air into the Air Duct (2) and delivers it through the Air Delivery Device (4) at the bottom of the Composter Box (3). The injected air then travels through the composting material in an upward movement caused by the air being lighter than the composting material as well as chemical dispersion.

With air circulating through the composting material the microbiological activity is enhanced. In this way the composting process is accelerated without the need of additional mechanical action, such as turning the composting material.

Any source of clean (oil free) compressed air may be used. One of the preferred method of pumping air is the use of an air pump driven by a solar module. This type of air source has the advantages of being independent from other energy sources, voids the need for power cables and provides a natural cycle of pumping and resting throughout the day and night cycle. Furthermore, the solar powered air pumping tends to be self-adjusting according to the seasons. More pumping is done at summer, when temperatures are warmer and robust bacterial activity is expected.

Given that composting is a slow process of digesting and metabolizing organic matter, the volume of air needed is low if injected directly into the composting material. In the case of a composter sized for a normal size family garden, a very small air pump (i.e. fish tank air pump) would more than match the demand for air.

Another special advantage of the AIR INJECTED COMPOSTER is that it does not require a highly ventilated enclosure and it may be built thermally insulated for faster composting in areas with cold weather. In this particular case, by allowing the composter to keep more of the heat generated, a more benign environment for bacterial activity results in a faster composting process.

The preferred point of air injection is at the bottom of the box, near the center. More elaborate devices for air injection may be used such as segments of semi-permeable hoses or bladders. The semi-permeable hose offers a better distribution of air throughout the area. The bladder type, if used with a cyclic type of air source, would also have the tendency to inflate and deflate throughout the “on-of” cycles, causing the compost matter to move, improving the air distribution and stimulating the composting process even further. The final determination regarding volume and method of injecting air depends largely on the size and shape of the composter box, as well as, the time expected for the organic matter to turn into compost.

If the composter is to be used in arid areas, it may be built to collect and hold rain/irrigation water so proper moisture levels are kept. Furthermore, in areas of extreme dry weather, the composter box may be supplied with a water reservoir that slowly delivers water for keeping proper moisture levels.

Finally, the composter box may be built without a bottom to allow the nutrients to migrate into the ground and fertilize the soil and plants surrounding it.

As the organic debris is turned into compost, the volume decreases making room for more organic material. Once a given “bottom-less” composter box fills up, it can be lifted to remove the compost and then placed back with the material not yet composted. No other manual intervention is needed.

This invention places little demands on the shape or size of the composter box and it can be built in a number of ornamental shapes to harmonize with the aesthetics of the place where used. Given that the composter is simple and low cost to build, a number of “bottoms-less mini-composters” can be placed in strategic places around a garden without adversely affecting the aesthetics. Also, given the low demand on the air pump, it can be made small, inexpensive and inconspicuous.

Although only an exemplary embodiment of the invention has been described in the detailed description above, those skilled in the art will readily appreciate that many modifications are possible without materially departing from the novel teachings of this invention. Accordingly, all such modifications are intended to be included within the scope of this invention as defined in the following claims.

1. An air injected composter comprising:
a composter box with an access opening for adding organic material and a second access near the bottom for removing the compost;
a source of compressed air;
an air duct to deliver the air into the compost box;
an air delivery device that may consist of:
a simple tube opening or;
a segment or segments of semi permeable hose or;
a bladder or bladders made with semi-permeable material or;
penetrations through the bottom of the composter box.

2. The air injected composter of claim 1 provided with the means to collect rainwater or irrigation water to keep proper level of moisture in the composting material.

3. The air injected composters of claims 1 and 2 where the composter box is built without a bottom to allow the free flow of the nutrients released by the composting process into the soil.
